(19) United States
(12) Patent Application Publication
(10) Pub. No.: US 2008/0277180 A1
(43) Pub. Date: Nov. 13, 2008

(54) LIGHTWEIGHT PROPULSION DEVICE FOR PROVIDING MOTIVE FORCE TO A SKATE EQUIPMENT USER

(75) Inventor: William Waldron PITT, Livermore, CA (US)

Correspondence Address: TILLMAN WRIGHT, PLLC, P.O. BOX 471581, CHARLOTTE, NC, 28247, US

(73) Assignee: BOUNCING BRAIN INNOVATIONS SEASON TWO SUBSIDIARY 12, LLC, Charlotte, NC (US)

(21) Appl. No.: 12/176,351

(22) Filed: Jul. 19, 2008

Related U.S. Application Data
(63) Continuation of application No. 11/770,732, filed on Jun. 28, 2007.
(60) Provisional application No. 60/817,262, filed on Jun. 28, 2006.

(51) Int. Cl. B62M 29/00; B62M 1/00

(52) U.S. Cl. 180/186; 280/221

(57) ABSTRACT

A propulsion device for use with skate equipment includes a frame having an upper end and a lower end, an engine, a single wheel and a hand grip. The engine is mounted substantially above the lower end of the frame. The single wheel is mounted at the lower end of the frame and operatively connected with the engine to be driven thereby. The hand grip is mounted on the frame above the engine and is angled upward away from the frame when the propulsion device is placed in its normal angle of use.

### CROSS-REFERENCE TO RELATED APPLICATION

The present application is a continuation of, and claims priority under 35 U.S.C. § 120 to, U.S. patent application Ser. No. 11/770,732, filed Jun. 28, 2007, which is a nonprovisional patent application of, and claims priority under 35 U.S.C. § 119(e) to, U.S. provisional patent application Ser. No. 60/817,262, filed Jun. 28, 2006. The entire disclosure of each of these patent applications is incorporated by reference herein.

### COPYRIGHT STATEMENT

All of the material in this patent document is subject to copyright protection under the copyright laws of the United States and of other countries. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE PRESENT INVENTION

1. Field of the Present Invention

The present invention generally relates to auxiliary propulsion equipment, and, in particular, to equipment which is used in conjunction with skate equipment including skateboards, mountain and off-road boards, long boards, inline skates, roller skates and other similar friction-reducing wheeled equipment being used over a variety of terrains.

2. Background

Users of skate equipment, particularly including skateboards but also including inline skates and roller blades, have long sought means to motorize their equipment. any kind of skate equipment. More particularly, such users have sought means for propelling themselves with an auxiliary power device that is not attached to the preferred skating means.

A number of self-contained small motorized scooter devices for transportation and recreation have been produced, but the efforts to produce outboard-type devices sold specifically for “skaters,” i.e. skateboarders, inline and roller skaters, and people with similar wheeled devices, have been more limited.

In particular, skaters have sought a motorized device that may be held in the skater's hands but which provides desired stability and maneuverability. More particularly, skaters have sought a device that may be held on their side, with their hands spaced apart, with their upper body or their entire body (such as when riding a skateboard) turned to the side, to achieve these goals. Non-motorized devices offering some of these advantages have been produced, but motorized devices have not. From a practical standpoint this has left many skaters to use only human power to propel themselves. Previously going up hills and any distance of consequence was more of a burden than a pleasurable experience for skaters.

### SUMMARY OF THE PRESENT INVENTION

The present invention includes many aspects and features.

In one aspect of the invention, a propulsion device for use with skate equipment includes: a frame having an upper end and a lower end; an engine mounted on the frame; a single wheel mounted at the lower end of the frame and operatively connected with the engine to be driven thereby; a first hand grip mounted on the frame above the engine, spaced apart from the upper end of the frame when the propulsion device is placed in its normal angle of use; and a second hand grip adjacent the upper end of the frame.

In a feature, the hand grip is spaced substantially apart from the upper end of the frame.

In connection with this feature, a skater support bar may be mounted on the frame above the engine and below the hand grip and may be adapted to provide motive force from the frame to a skater's leg. The engine may be arranged to be closer to the hand grip than to the lower end of the frame, and the frame may include an upper support handle and a lower support handle.

The propulsion device also may include a hinge mechanism and a securing mechanism, and the upper support handle may be rotated relative to the lower support handle via the hinge mechanism. The engine also may be mounted at an upper end of the lower support handle and, in this regard, the lower support handle may include a drive shaft housing and the propulsion device further may include a drive shaft, extending through the drive shaft housing, that operatively couples rotational motion generated by the engine to the wheel.

The propulsion device also may include a centrifugal clutch coupled to the engine and a drive assembly having a drive gear operatively coupled to the centrifugal clutch, a drive shaft operatively coupled to the drive gear, and a driven gear operatively coupled to the drive shaft, wherein the driven gear is mounted on the wheel and imparts motion thereto. The propulsion device also may include a drive assembly having a drive sprocket operatively coupled to the centrifugal clutch, a chain operatively coupled to the drive sprocket, and a driven sprocket operatively coupled to the chain, wherein the driven sprocket is mounted on the wheel and imparts motion thereto.

The propulsion device also may include a brake lever that is equipped to be adjusted from a position adapted for use by a right-handed user to a positioned adapted for use by a left-handed user.

In another feature, the hand grip is angled to one side of the frame, and the hand grip is equipped to be selectively angled to one side of the frame or the other.

In another feature, the hand grip is angled upward away from the frame in an orientation slightly above horizontal when the propulsion device is placed in its normal angle of use and the upward angle of the hand grip may be adjustable.

In another aspect of the invention, a method of propelling a skate equipment user includes providing propulsion device, including (i) a frame having an upper end and a lower end, (ii) an engine mounted on the frame, a single wheel mounted at the lower end of the frame and operatively connected with the engine to be driven thereby, (iv) a first hand grip mounted on the frame above the engine, spaced apart from the upper end of the frame when the propulsion device is placed in its normal angle of use, and a second hand grip adjacent the upper end of the frame. The method also includes holding, by the user, the propulsion device at the user's side, the step of holding including gripping the first hand grip with one hand and the second hand grip with the other hand.

In addition to the aforementioned aspects and features of the present invention, it should be noted that the present invention further encompasses the various possible combinations of such aspects and features, as well as aspects and features otherwise disclosed herein.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a right rear perspective view of a propulsion device in accordance with a first preferred embodiment of the present invention;

FIG. 2 is a top plan view of the propulsion device of FIG. 1;

FIG. 3 is a right side plan view of the propulsion device of FIG. 1;

FIG. 4 is an enlarged left rear perspective view of a lower portion of the propulsion device of FIG. 1;

FIG. 5A is a left side view of the device of FIG. 1, illustrating the use of the device, including the natural body position of the user while using the device;

FIG. 5B is a left side view of the device of FIG. 1, illustrating the use of the device when lifted off the ground for jumps, tricks or the like;

FIG. 6 is a perspective view of the propulsion device of FIG. 1, shown collapsed or folded into its compact state;

FIG. 7 is a right side plan view of a propulsion device in accordance with a second preferred embodiment of the present invention;

FIG. 8 is a top plan view of the device of FIG. 7;

FIG. 9 is an enlarged right side plan view of the drive assembly components at the lower end of the propulsion device of FIG. 7;

FIG. 10 is a left side view of the device of FIG. 7, illustrating the use of the device, including the natural body position of the user while using the device;

FIG. 11 is a top plan view of the propulsion device of FIG. 7, shown collapsed or folded into its compact state; and

FIGS. 12 and 13 are a top plan view and left side plan view, respectively, of a propulsion device in accordance with a third preferred embodiment of the present invention.

### DETAILED DESCRIPTION OF THE PREFERRED EMBODIMENTS

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of the preferred embodiment(s) is merely exemplary in nature and is in no way intended to limit the invention, its application, or uses.

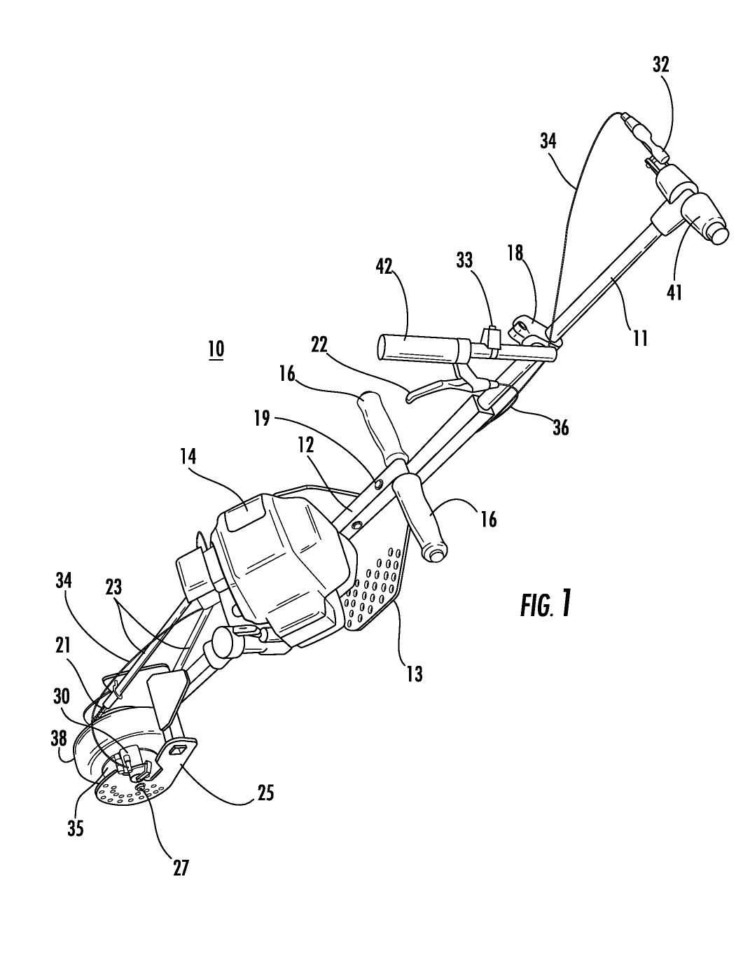

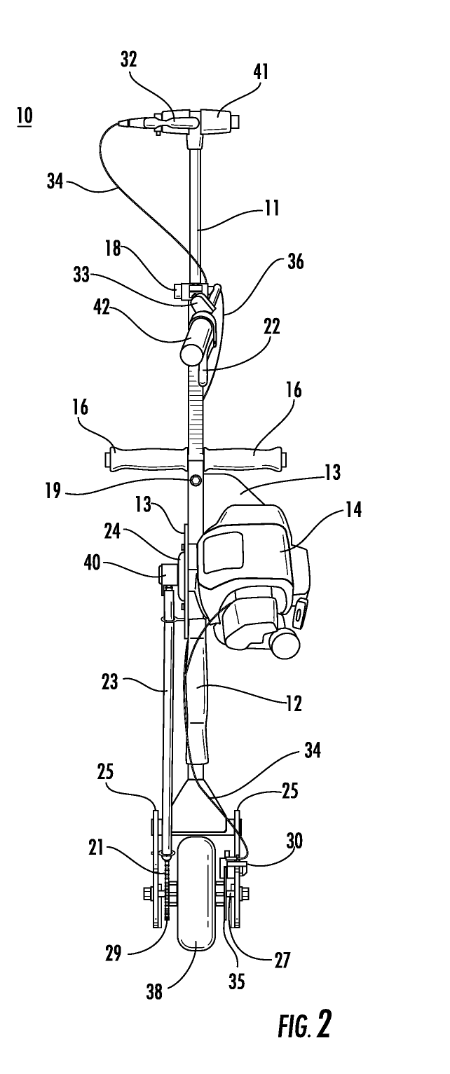

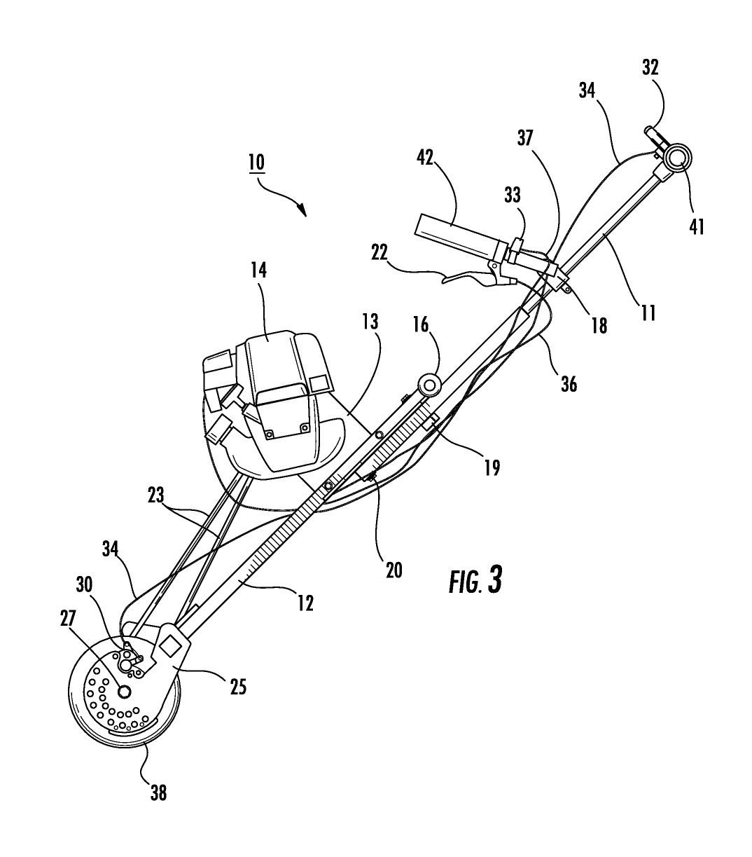

FIG. 1 is a right rear perspective view of a propulsion device 10 in accordance with a first preferred embodiment of the present invention, while FIGS. 2 and 3 are a top plan view and right side plan view, respectively, of the propulsion device 10 of FIG. 1. As shown therein, the propulsion device 10 includes a combustion engine 14, a wheel assembly, a drive assembly and a brake assembly, all supported by a frame that includes an upper support handle 11 and a lower support handle 12 as well as a variety of controls and other mechanisms. Each of these elements will be described in greater detail hereinbelow.

The upper support handle 11 includes an upper hand grip 41, located at the upper end of the upper support handle 11, and a lower hand grip 42, located midway between the upper and lower ends of the upper support handle 11. The upper hand grip 41 is preferably T-shaped with respect to the upper end of the support handle 11, thereby accommodating use by both right-handed and left-handed users without adjustment thereof, and may be padded for user comfort. However, in at least one alternative embodiment, the upper hand grip 41 may extend in only one direction from the upper end of the support handle 11 and may optionally be arranged to be adjustable for accommodating both right-handed and left-handed users. Still further, in at least one other alternative embodiment, the upper hand grip may be omitted altogether.

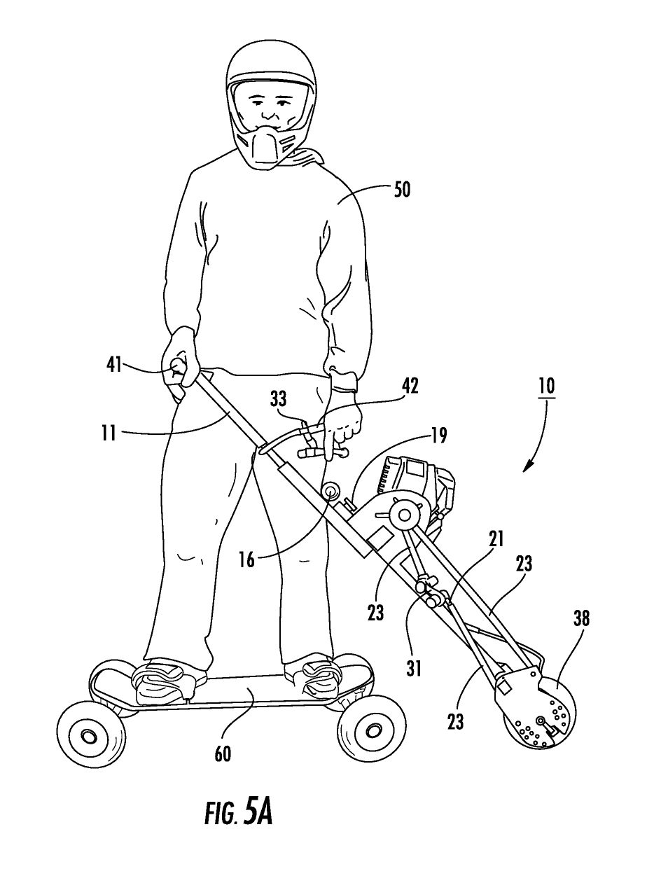

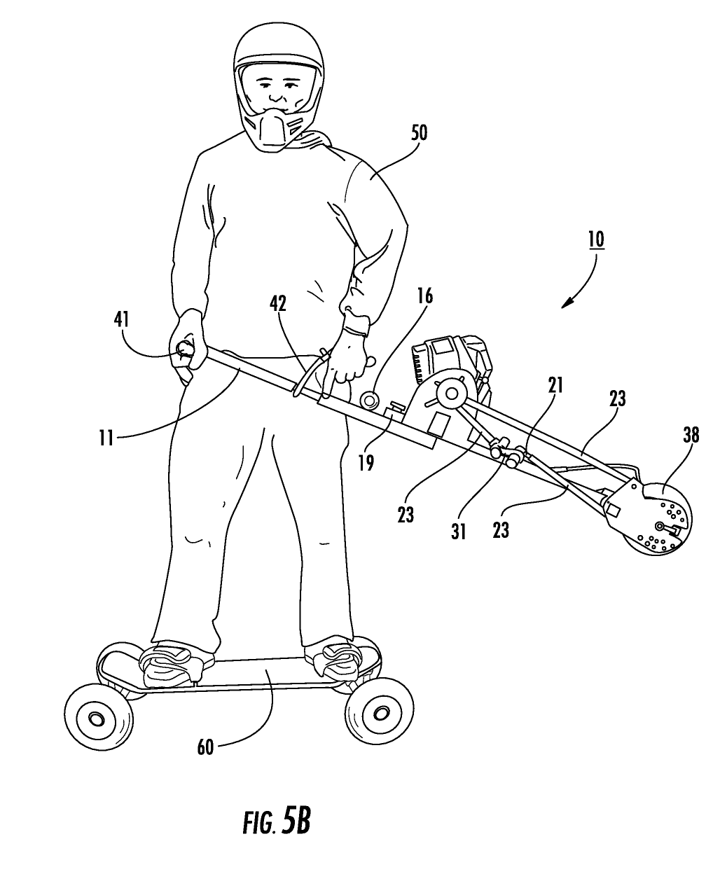

The upper hand grip 41 may further include attached thereto a brake lever 32. The brake lever 32 is operatively connected to a disk brake mechanism 30 via a brake cable 34 and is used to brake the rotation of the wheel assembly. As such, the brake lever 32 is preferably a conventional brake lever that may be manipulated by the user's fingers, as approximately shown in FIG. 5A. When used with the illustrated T-shaped upper hand grip 41 or hand grips that may adjusted to accommodate right- and left-handed users, the brake lever 32 is preferably movable, adjustable, or both in order to likewise accommodate both right-handed and left-handed users.

The lower hand grip 42 is preferably a single projecting member that is angled relative to the main axis of the frame in two dimensions. First, the lower hand grip 42 is angled upward and rearward relative to the upper support handle 11, as perhaps best seen in FIG. 3. This enables the user to hold the grip 42 to position the device 10 in both an operative position, shown in FIG. 5A, and in a raised position, shown in FIG. 5B. Preferably, the lower hand grip 42 is oriented so as to be angled slightly upward from horizontal during use, as shown in FIG. 3, thereby providing a more ergonomic position for gripping. Second, the lower hand grip 42 is angled or canted to one side, as perhaps best seen in FIG. 2. This provides a more ergonomic position for gripping, with the direction in which the grip 42 is angled being dependent on whether the grip 42 is to be held in the user's right or left hand. For example, as illustrated, the grip 42 is angled in such a way as to better accommodate gripping by the user's left hand. The connection between the lower hand grip 42 and the support handle 11 is made by a grip support 18, which in at least some embodiments provides adjustability in both dimensions and in particular may be adjusted for a right-handed person or a left-handed person, as appropriate.

The lower hand grip 42 may further include attached thereto a throttle mechanism 22 and a kill switch 33. The throttle mechanism 22 is operatively connected to the combustion engine 14 via a throttle cable 36 and is used to engage the clutch 24 and control the engine throttle, thereby varying the speed of the engine 14. As such, the throttle mechanism 22 preferably includes a conventional hand lever that may be manipulated by the user's fingers, as shown in FIG. 5A. As will be apparent, however, other throttle mechanisms may be used, such as a rotary handle control of the type often found on motorcycles. The kill switch 33 is operatively connected to the combustion engine 14 via a kill switch wire 37 and is used to kill the engine 14 in an emergency situation or at the end of use of the device 10. As such, the kill switch 33 preferably includes a conventional push button or other mechanism that may be manipulated by the user's thumb.

The lower support handle 12 includes a skater support bar 16 at its upper end, an engine mount 13 near its upper end for the combustion engine 14, and a fork 25 at its lower end. In at least one embodiment, the skater support bar 16 is rotatably attached to the lower support handle 12 to facilitate adjustment of its position. The upper and lower support handles 11,12 may each be integrally formed from heavy gauge aluminum, titanium, carbon fiber, or the like for structural rigidity, or may rigidly assembled from discrete elements of similar construction. A construction material suitable for use in the preferred embodiments of the present invention is TIG welded 6061 aluminum. The upper support handle 11 preferably comprises a separate assembly that may be moved relative to the lower support handle 12 when a suitable securing mechanism 19 is released as described more fully hereinbelow.

The combustion engine 14 is mounted to the support of the lower support handle 12, thereby being positioned in the approximate middle of the frame, with bolts, clamps or the like. The combustion engine preferably includes a centrifugal clutch 24. A combustion engine suitable for use is a 4-stroke 1.6 horsepower EPA- and C.A.R.B.-compliant engine such as the Subaru Robin model EHO35.

The drive assembly includes a drive sprocket 40, connected to the centrifugal clutch 24, as well as a chain 21 and a driven sprocket 29. Under the control of the throttle mechanism 22, rotational motion from the combustion engine 14 is transferred through the centrifugal clutch 24 to the drive sprocket 40, thereby moving the chain 21 which in turn translates motion to the driven sprocket 29. Optionally, the chain 21 may be kept in proper tension by a chain tensioner 31, shown in FIGS. 5A and 5B, which takes up slack in the chain 21 by twisting about its axis. Chain guard elements 23 protect the user from contact with the moving chain 21 and protect the chain 21 from objects and debris encountered during use.

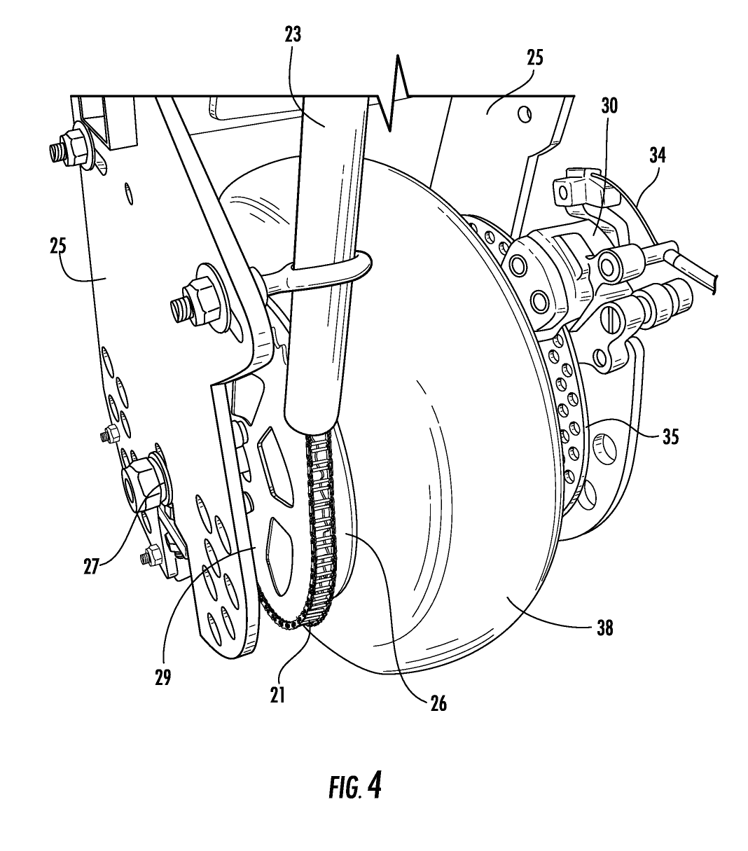

FIG. 4 is an enlarged left rear perspective view of a lower portion of the propulsion device 10 of FIG. 1. As perhaps best shown therein, the wheel assembly includes a wheel rim 39 on which a traction wheel 38 is mounted. The driven sprocket 29 is mounted on one side of the wheel rim 39, which is rotatably mounted on an axle 27 that is affixed to the fork 25. Motion is translated from the driven sprocket 29 to the traction wheel 38 via the wheel rim 39.

The brake assembly includes the hand-operated brake lever 32 and the brake cable 34, a disk brake mechanism 30 mounted to the fork 25, and a brake disk 35 that is preferably mounted to the wheel rim 39 on the opposite side from the driven sprocket 29. Braking force is translated from the brake lever 32 through the brake cable 34 to the brake mechanism 30, which ultimately slows the traction wheel 38 via friction applied to the brake disk 35, which is mounted to wheel rim 39.

In use, the device 10 is first positioned in suitable disposition such that the engine 14 may be started in a conventional manner. Since there is a centrifugal clutch 24 operatively interposed between the engine 14 and the traction wheel 38, the traction wheel 38 will remain motionless, even with the engine idling, until the clutch 24 is engaged via the throttle mechanism 22. Once the combustion engine 14 is started, but preferably before the clutch 24 is engaged, the traction wheel 38 can be placed on the ground to provide the user 50 with support and balance. FIG. 5A is a left side view of the device 10 of FIG. 1, illustrating the use of the device 10, including the natural body position of the user 50 while using the device 10.

Once the throttle mechanism 22 is squeezed, the throttle cable 36 will cause the RPM's of the combustion engine 14 to increase. When sufficient RPM's have been achieved, the centrifugal clutch 24 will engage, thereby turning the drive sprocket 29, causing the chain 21 to move, and turning the driven sprocket 40. This, in turn, causes the wheel rim 39 to rotate, thereby rotating the traction wheel 38 to rotate and thus imparting forward motion to the device 10.

The driving force from the propulsion device 10 is translated to the user by the skater support bar 16 which will push on the user's leg, or in some cases, the user's legs. The geometry of the skater support bar 16 and hand grips 41,42 is preferably selected to position the support bar 16 at the back or side of the user's lower thigh or behind the user's knee when the user 50 is riding a skateboard 60 as illustrated in FIG. 5A. In this arrangement, the user 50 conventionally uses a stance in which one foot is positioned on the forward end of the skateboard 60 and the other foot is positioned near the rearward end of the skateboard 60, thereby defining a forward leg and a rearward leg. As illustrated, the support bar 16 is perhaps best placed against the user's rearward leg.

Notably, during more acrobatic and aggressive riding the user 50 can choose to be pushed by holding on to just the lower hand grip 42, just the upper hand grip 41, just some other portion of the upper end of the main support handle 11, or some combination thereof. In fact, any combination of the skater support bar 16, lower hand grip 42, upper hand grip 41, or the upper end of the main support handle 11 may be used to translate motive force from the device 10 to the user.

When a user 50 needs to slow down, he or she may actuate the brake lever 32. Braking force is translated via the brake cable 34 to the brake mechanism 30, thereby slowing or stopping the traction wheel 38 which in turn slows the user 50 to the desired speed or a complete stop.

During use, the user 50 may also choose to lift the traction wheel 38 off the ground, either to quickly disengage the driving force imparted thereby, to provide greater maneuverability, to perform a trick or other acrobatic maneuver, or the like. In such a situation, the upper and lower handle grips 41,42 may be used to lift the entire device 10 off of the ground to the desired position. FIG. 5B is a left side view of the device 10 of FIG. 1, illustrating the use of the device 10 when lifted off the ground for jumps, tricks or the like.

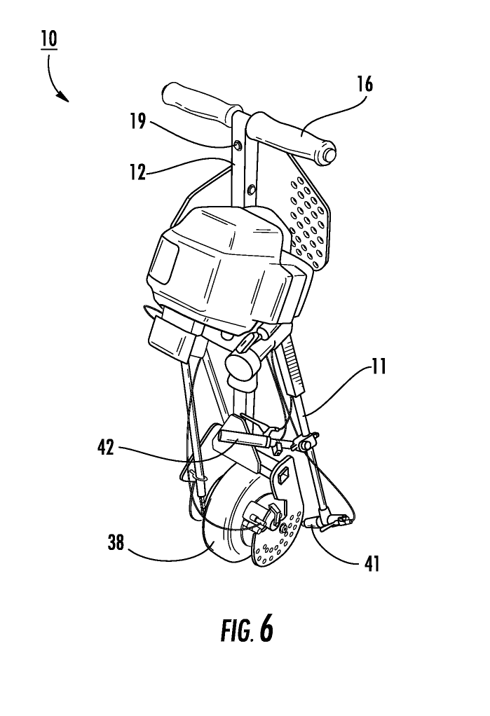

Preferably, when not in use, the propulsion device 10 of the present invention may be collapsed or folded to a compact state, thereby making transport and storage more convenient. As described previously, the upper support handle 11 preferably comprises a separate assembly that may be moved relative to the lower support handle 12 when a suitable securing mechanism 19 is released. More particularly, the upper support handle 11 is preferably connected to the lower support handle 12 by a hinge mechanism 20 and a securing mechanism 19, perhaps best shown in FIG. 3. The hinge mechanism 20 may be as simple as a single conventional bolt around which the upper support handle 11 may be rotated relative to the lower support handle 12 when the securing mechanism 19 is released. In this regard, the securing mechanism 19 may likewise be as simple as a single conventional bolt, preferably having a finger wheel that may be tightened sufficiently by hand (i.e., without the use of tools) to maintain the relative rigidity of the upper support handle 11 relative to the lower support handle 12 but which may be loosened by hand and removed easily when the user desires to collapse or fold the device 10 into the compact state. FIG. 6 is a perspective view of the propulsion device 10 of FIG. 1, shown collapsed or folded into its compact state. The hinge mechanism 20 and securing mechanism 19 are preferably disposed in locations suitable for making the propulsion device as compact as is reasonably possible.

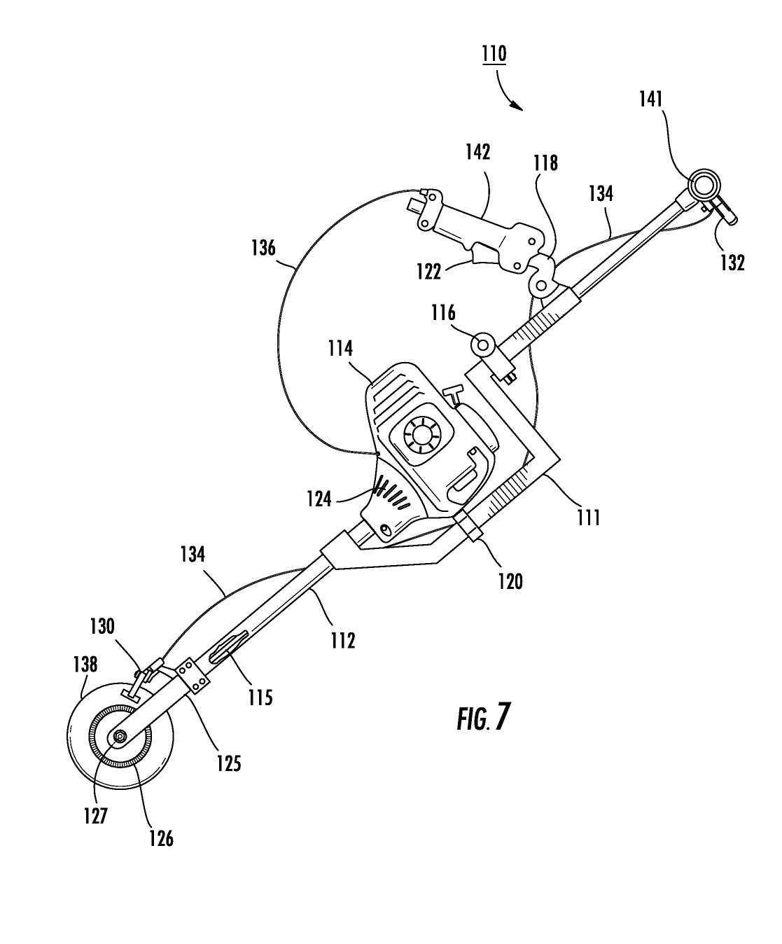

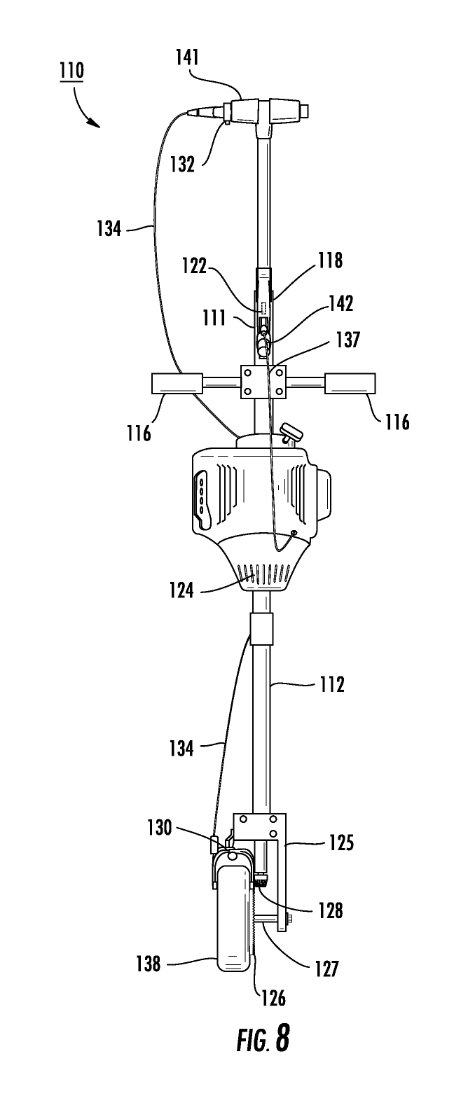

FIG. 7 is a right side plan view of a propulsion device 110 in accordance with a second preferred embodiment of the present invention, FIG. 8 is a top plan view of the device 110 of FIG. 7. As shown therein, the propulsion device 110 includes a combustion engine 114, a wheel assembly, a drive assembly and a brake assembly, all supported by a frame that includes an upper support handle 111 and a lower support handle 112 as well as a variety of controls and other mechanisms. Each of these elements will be described in greater detail hereinbelow.

The upper support handle 111 includes an upper portion and a lower angle and offset portion, with the latter functioning to accommodate a central location of the engine 114 as discussed below. As perhaps best seen in FIG. 7, an upper hand grip 141 is located at the upper end of the upper support handle 111, a lower hand grip 142 is located midway between the upper end of the upper support handle 111 and the angle and offset portion of the handle 111, and a skater support bar 116 is located adjacent the point where the upper portion of the handle 111 meets the angle and offset portion. In at least one embodiment, the skater support bar 116 is rotatably attached to the upper support handle 111 to facilitate adjustment of its position.

The upper hand grip 141 is preferably T-shaped with respect to the upper end of the support handle 111, thereby accommodating use by both right-handed and left-handed users without adjustment thereof, and may be padded for user comfort. However, in at least one alternative embodiment, the upper hand grip 141 may extend in only one direction from the upper end of the support handle 111 and may optionally be arranged to be adjustable for accommodating both right-handed and left-handed users. Still further, in at least one other alternative embodiment, the upper hand grip may be omitted altogether.

The upper hand grip 141 may further include attached thereto a brake lever 132. The brake lever 132 is operatively connected to a disk brake mechanism 130 via a brake cable 134 and is used to brake the rotation of the wheel assembly. As such, the brake lever 132 is preferably a conventional brake lever that may be manipulated by the user's fingers in similar fashion to that approximately shown in FIG. 5A. When used with the illustrated T-shaped upper hand grip 141 or hand grips that may adjusted to accommodate right- and left-handed users, the brake lever 132 is preferably movable, adjustable, or both in order to likewise accommodate both right-handed and left-handed users.

The lower hand grip 142 is preferably a single projecting member that is angled upward and rearward relative to the upper support handle 111 as shown in FIG. 7. This enables the user to hold the grip 142 to position the device 110 in both an operative position, similar to that shown in FIG. 5A, and in a raised position, similar to that shown in FIG. 5B. Preferably, the lower hand grip 142 is oriented so as to be angled slightly upward from horizontal during use, as shown in FIG. 7, thereby providing a more ergonomic position for gripping. The connection between the lower hand grip 142 and the support handle 111 is made by a grip support 118, which in at least some embodiments provides adjustability upward and downward.

The lower hand grip 142 may further include attached thereto a throttle mechanism 122. The throttle mechanism 122 is operatively connected to the combustion engine 114 via a throttle cable 136 and is used to engage the clutch 124 and control the engine throttle, thereby varying the speed of the engine 114. As such, the throttle mechanism 122 preferably includes a conventional actuating mechanism that may be manipulated by the user's fingers, in somewhat similar fashion to that shown in FIG. 5A. As will be apparent, however, other throttle mechanisms may be used, such as a rotary handle control of the type often found on motorcycles. Though not shown, a kill switch may further be provided to enable the user 50 used to kill the engine 114 in an emergency situation or at the end of use of the device 110. Such a kill switch may comprise a conventional push button or other mechanism that may be manipulated by the user's thumb.

The lower support handle 112 includes an offset portion at its upper end and a drive shaft housing with a fork 125 extending therefrom at its lower end. The combustion engine 114 is affixed with bolts, clamps or the like at the upper end of the drive shaft housing. The offset portions of the upper and lower support handles 111,112 permit the engine 114 to be disposed directly in line between the drive shaft housing and the upper portion of the upper support handle 111, thereby affecting the center of gravity and balance of the device 110. The upper and lower support handles 111,112 may each be rigidly assembled from discrete elements of heavy gauge aluminum, titanium, carbon fiber, or the like for structural rigidity, or may be integrally formed from similar materials. A construction material suitable for use in the preferred embodiments of the present invention is TIG welded 6061 aluminum. The upper support handle 111 preferably comprises a separate assembly that may be moved relative to the lower support handle 112 when a suitable securing mechanism is released as described more fully hereinbelow.

In its position at the top of the drive shaft housing, the combustion engine 114 is thereby being positioned in the approximate middle of the frame. The combustion engine preferably includes a centrifugal clutch 24. A combustion engine suitable for use is a 2-stroke 23 cc EPA- and C.A.R.B.-compliant engine such as the Mitsubishi model TL23.

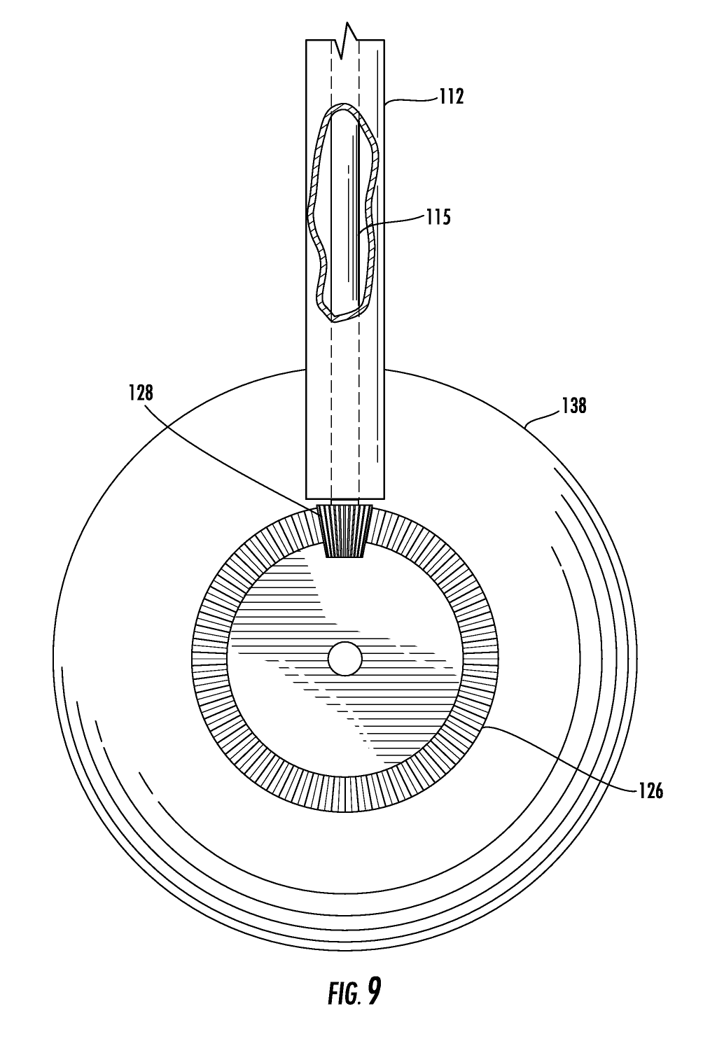

FIG. 9 is an enlarged right side plan view of the drive assembly components at the lower end of the propulsion device 110 of FIG. 7. As perhaps best shown therein, the drive assembly includes a drive shaft 115, a drive gear 128 and a driven gear 126. Under the control of the throttle mechanism 122, rotational motion from the combustion engine 114 is transferred through the centrifugal clutch 124 to the drive shaft 115 and thus the drive gear 128 located at is lower end. The drive shaft housing protects the user from contact with the rotating drive shaft 115 and protect the drive shaft 115 from objects and debris encountered during use.

Returning again to FIGS. 7 and 8, the wheel assembly includes a wheel rim on which a traction wheel 138 is mounted. The driven sprocket 129 is mounted on one side of the wheel rim, which is rotatably mounted on an axle 127 that is affixed to the fork 125. Motion is translated from the driven sprocket 129 to the traction wheel 138 via the wheel rim.

The brake assembly includes the hand-operated brake lever 132 and the brake cable 134 and a caliper disk brake mechanism 130 mounted to the fork 125. Braking force is translated from the brake lever 132 through the brake cable 134 to the brake mechanism 130, which ultimately slows the traction wheel 138 via friction applied to the wheel rim.

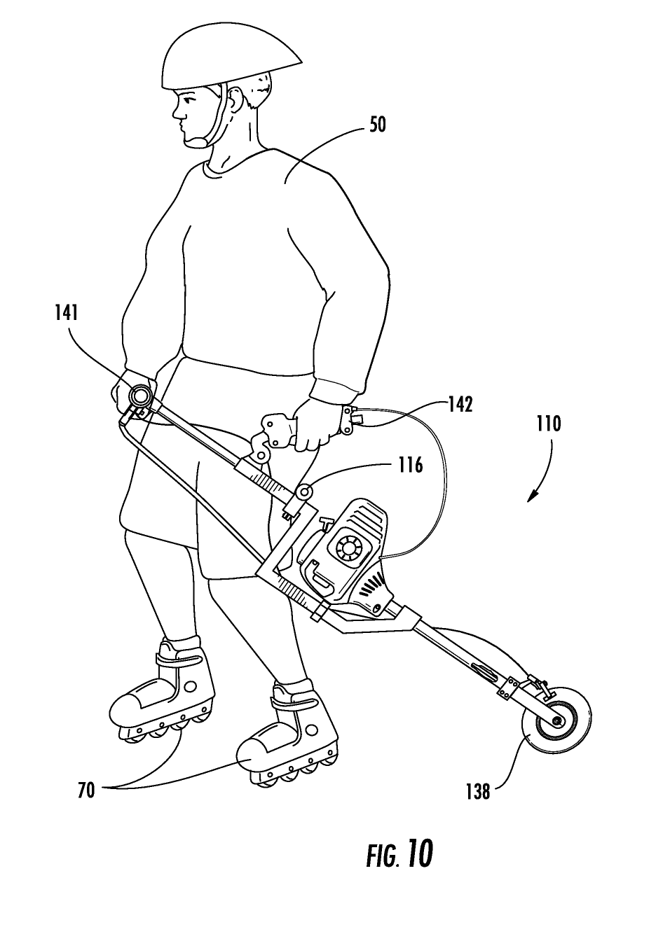

In use, the device 110 is first positioned in suitable disposition such that the engine 114 may be started in a conventional manner. Since there is a centrifugal clutch 124 operatively interposed between the engine 114 and the traction wheel 138, the traction wheel 138 will remain motionless, even with the engine idling, until the clutch 124 is engaged via the throttle mechanism 122. Once the combustion engine 114 is started, but preferably before the clutch 124 is engaged, the traction wheel 138 can be placed on the ground to provide the user 50 with support and balance. FIG. 10 is a left side view of the device 110 of FIG. 7, illustrating the use of the device 110, including the natural body position of the user 50 while using the device 110. In the arrangement illustrated in FIG. 10, the user is wearing inline skates 70, but it will be apparent that the device 110 of FIGS. 7-10 may instead be utilized by a skateboarder 50 in similar fashion to that shown in FIG. 5A.

Once the throttle mechanism 122 is squeezed, the throttle cable 136 will cause the RPM's of the combustion engine 114 to increase. When sufficient RPM's have been achieved, the centrifugal clutch 124 will engage, thereby turning the drive shaft 115 and likewise causing the drive gear 128 to rotate. Rotational force will be changed 90 degrees by the connection between drive gear 128 and wheel rim with driven gear 126. This, in turn, causes the wheel rim to rotate, thereby causing the traction wheel 138 to rotate and thus imparting forward motion to the device 110.

The driving force from the propulsion device 110 is translated to the user by the skater support bar 116 which will push on the user's leg, or in some cases, the user's legs. The geometry of the skater support bar 116 and hand grips 141,142 is preferably selected to position the support bar 116 at the back or side of the user's lower thigh or behind the user's knee when the user 50 is riding a skateboard 60 as illustrated in FIG. 5A. In this arrangement, the user 50 conventionally uses a stance in which one foot is positioned on the forward end of the skateboard 60 and the other foot is positioned near the rearward end of the skateboard 60, thereby defining a forward leg and a rearward leg. As illustrated, the support bar 116 is perhaps best placed against the user's rearward leg.

Notably, during more acrobatic and aggressive riding the user 50 can choose to be pushed by holding on to just the lower hand grip 142, just the upper hand grip 141, just some other portion of the upper end of the main support handle 111, or some combination thereof. In fact, any combination of the skater support bar 116, lower hand grip 142, upper hand grip 141, or the upper end of the main support handle 111 may be used to translate motive force from the device 110 to the user.

When a user 50 needs to slow down, he or she may actuate the brake lever 132. Braking force is translated via the brake cable 134 to the brake mechanism 130, thereby slowing or stopping the traction wheel 138 which in turn slows the user 50 to the desired speed or a complete stop.

During use, the user 50 may also choose to lift the traction wheel 138 off the ground, either to quickly disengage the driving force imparted thereby, to provide greater maneuverability, to perform a trick or other acrobatic maneuver, or the like. In such a situation, the upper and lower handle grips 141,142 may be used to lift the entire device 110 off of the ground to the desired position. FIG. 5B is a left side view of the device 110 of FIG. 1, illustrating the use of the device 110 when lifted off the ground for jumps, tricks or the like.

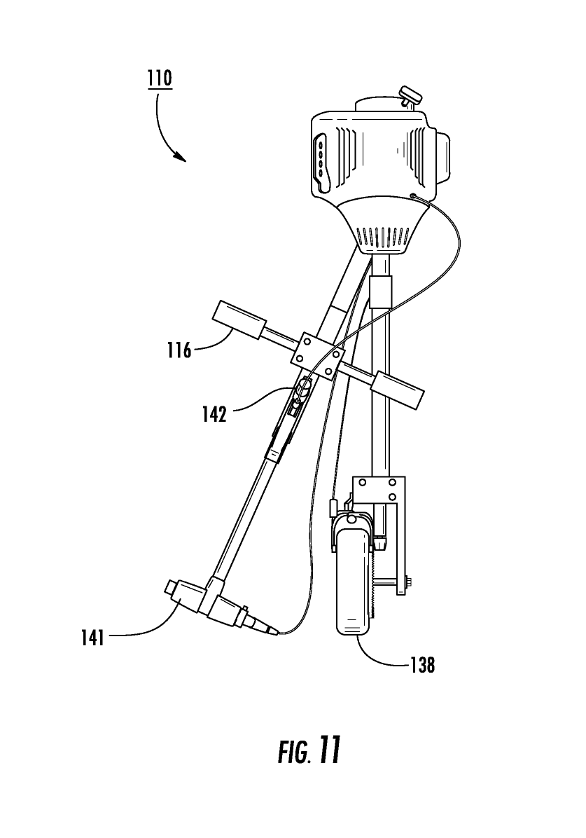

Preferably, when not in use, the propulsion device 110 of the present invention may be collapsed or folded to a compact state, thereby making transport and storage more convenient. As described previously, the upper support handle 111 preferably comprises a separate assembly that may be moved relative to the lower support handle 112 when a suitable securing mechanism is released. More particularly, the upper support handle 111 is preferably connected to the lower support handle 112 by a hinge mechanism 120 and a securing mechanism. The hinge mechanism 120 may be a dedicated hinge disposed on the side or front of the lower support handle 112 and around which the upper support handle 111 may be rotated relative to the lower support handle 112 when the securing mechanism is released. In this regard, the securing mechanism may be as simple as a single conventional bolt, preferably having a finger wheel that may be tightened sufficiently by hand (i.e., without the use of tools) to maintain the relative rigidity of the upper support handle 111 relative to the lower support handle 112 but which may be loosened by hand and removed easily when the user desires to collapse or fold the device 110 into the compact state. FIG. 11 is a top plan view of the propulsion device 110 of FIG. 7, shown collapsed or folded into its compact state. The hinge mechanism 120 and securing mechanism are preferably disposed in locations suitable for making the propulsion device as compact as is reasonably possible.

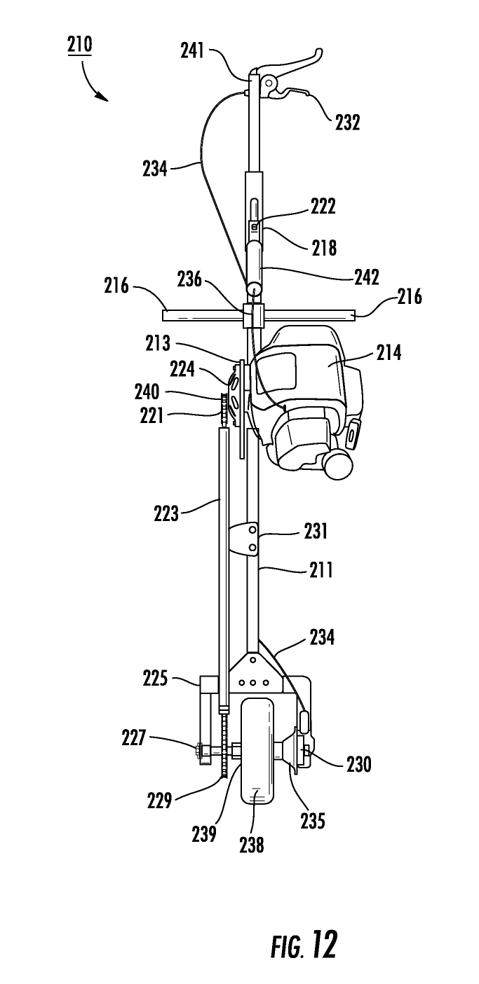

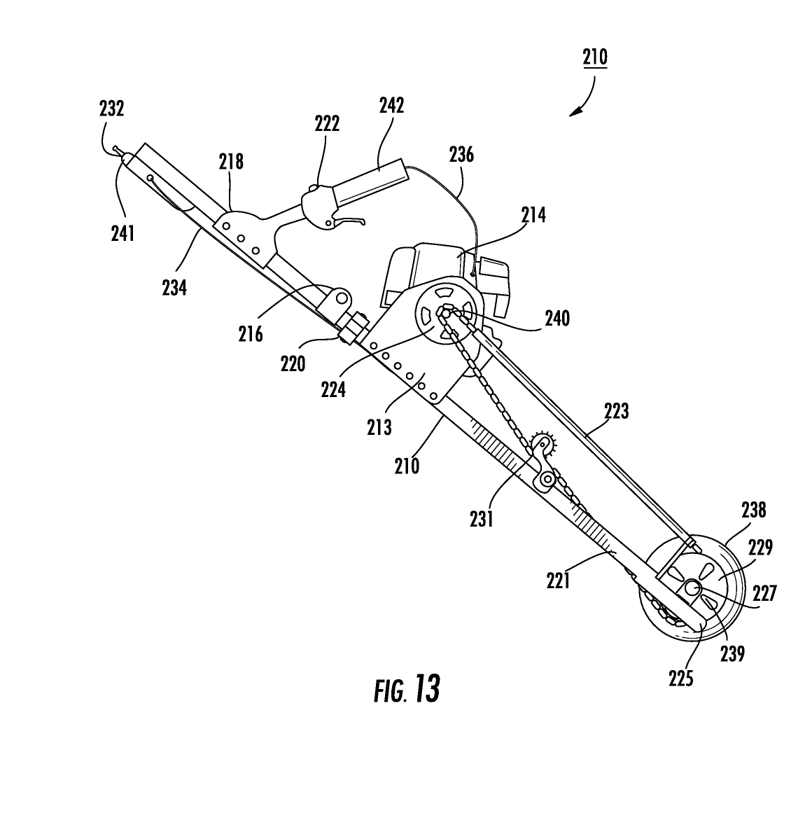

FIGS. 12 and 13 are a top plan view and left side plan view, respectively, of a propulsion device 210 in accordance with a third preferred embodiment of the present invention. As shown therein, the propulsion device 210 includes a combustion engine 214, a wheel assembly, a drive assembly and a brake assembly, all supported by a frame that includes an upper support handle 211 and a lower support handle 212 as well as a variety of controls and other mechanisms. Each of these elements will be described in greater detail hereinbelow.

The upper support handle 211 includes an upper hand grip 241, located at the upper end of the upper support handle 211, and a lower hand grip 242, located midway between the upper and lower ends of the upper support handle 211. In this embodiment, the upper hand grip 241 comprises an L-shaped handle extending from one side of the upper end of the support handle 211, and may be padded for user comfort. The upper hand grip 241 may optionally be arranged to be adjustable for accommodating both right-handed and left-handed users. However, in at least one alternative embodiment, the upper hand grip 241 may be T-shaped with respect to the upper end of the support handle 211, thereby accommodating use by both right-handed and left-handed users without adjustment thereof. However, in at least one alternative embodiment, the upper hand grip may extend in only one direction from the upper end of the support handle 211 and may optionally be arranged to be adjustable for accommodating both right-handed and left-handed users. Still further, in at least one other alternative embodiment, the upper hand grip may be omitted altogether.

The upper hand grip 241 may further include attached thereto a brake lever 232. The brake lever 232 is operatively connected to a disk brake mechanism 230 via a brake cable 234 and is used to brake the rotation of the wheel assembly. As such, the brake lever 232 is preferably a conventional brake lever that may be manipulated by the user's fingers in similar fashion to that approximately shown in FIG. 5A. As will be apparent, however, other throttle mechanisms may be used, such as a rotary handle control of the type often found on motorcycles. When used with the illustrated adjustable L-shaped upper hand grip 241 or a T-shaped hand grip, the brake lever 232 is preferably movable, adjustable, or both in order to likewise accommodate both right-handed and left-handed users.

The lower hand grip 242 is preferably a single projecting member that is angled upward and rearward relative to the upper support handle 211 as shown in FIG. 13. This enables the user to hold the grip 242 to position the device 210 in both an operative position, similar to that shown in FIG. 5A, and in a raised position, similar to that shown in FIG. 5B. Preferably, the lower hand grip 42 is oriented so as to be angled slightly upward from horizontal during use, as shown in FIG. 13, thereby providing a more ergonomic position for gripping. The connection between the lower hand grip 242 and the support handle 211 is made by a grip support 218, which in at least some embodiments provides adjustability upward and downward.

The lower hand grip 242 may further include attached thereto a throttle mechanism 222. The throttle mechanism 222 is operatively connected to the combustion engine 214 via a throttle cable 236 and is used to engage the clutch 224 and control the engine throttle, thereby varying the speed of the engine 214. As such, the throttle mechanism 222 preferably includes a conventional hand lever that may be manipulated by the user's fingers, in similar fashion to that shown in FIG. 5A. Though not shown, a kill switch may further be provided to enable the user 50 used to kill the engine 214 in an emergency situation or at the end of use of the device 210. Such a kill switch may comprise a conventional push button or other mechanism that may be manipulated by the user's thumb.

The lower support handle 212 includes a skater support bar 216 at its upper end, an engine mount 213 near its upper end for the combustion engine 214, and a fork 225 at its lower end. In at least one embodiment, the skater support bar 216 is rotatably attached to the lower support handle 212 to facilitate adjustment of its position. The upper and lower support handles 211,212 may each be integrally formed from heavy gauge aluminum, titanium, carbon fiber, or the like for structural rigidity, or may rigidly assembled from discrete elements of similar construction. A construction material suitable for use in the preferred embodiments of the present invention is TIG welded 6061 aluminum. The upper support handle 211 preferably comprises a separate assembly that may be moved relative to the lower support handle 212 when a suitable securing mechanism is released as described more fully hereinbelow.

The combustion engine 214 is mounted to the support of the lower support handle 212, thereby being positioned in the approximate middle of the frame, with bolts, clamps or the like. The combustion engine preferably includes a centrifugal clutch 24. A combustion engine suitable for use is a 2-stroke 23 cc EPA- and C.A.R.B.-compliant engine such as the Mitsubishi model TL23.

The drive assembly includes a drive sprocket 240, connected to the centrifugal clutch 224, as well as a chain 221 and a driven sprocket 229. Under the control of the throttle mechanism 222, rotational motion from the combustion engine 214 is transferred through the centrifugal clutch 224 to the drive sprocket 240, thereby moving the chain 221 which in turn translates motion to the driven sprocket 229. Optionally, the chain 221 may be kept in proper tension by a chain tensioner 231, which takes up slack in the chain 221 by twisting about its axis. One or more chain guard elements 223 protect the user from contact with the moving chain 221 and protect the chain 221 from objects and debris encountered during use.

As shown in FIG. 12, the wheel assembly includes a wheel rim 239 on which a traction wheel 238 is mounted. The driven sprocket 229 is mounted on one side of the wheel rim 239, which is rotatably mounted on an axle 227 that is affixed to the fork 225. Motion is translated from the driven sprocket 229 to the traction wheel 238 via the wheel rim 239.

The brake assembly includes the hand-operated brake lever 232 and the brake cable 234, a disk brake mechanism 230 mounted to the fork 225, and a brake disk 235 that is preferably mounted to the wheel rim 239 on the opposite side from the driven sprocket 229. Braking force is translated from the brake lever 232 through the brake cable 234 to the brake mechanism 230, which ultimately slows the traction wheel 238 via friction applied to the brake disk 235, which is mounted to wheel rim 239.

In use, the device 210 is first positioned in suitable disposition such that the engine 214 may be started in a conventional manner. Since there is a centrifugal clutch 224 operatively interposed between the engine 214 and the traction wheel 238, the traction wheel 238 will remain motionless, even with the engine idling, until the clutch 224 is engaged via the throttle mechanism 222. Once the combustion engine 214 is started, but preferably before the clutch 224 is engaged, the traction wheel 238 can be placed on the ground to provide the user 50 with support and balance.

Once the throttle mechanism 222 is squeezed, the throttle cable 236 will cause the RPM's of the combustion engine 214 to increase. When sufficient RPM's have been achieved, the centrifugal clutch 224 will engage, thereby turning the drive sprocket 229, causing the chain 221 to move, and turning the driven sprocket 240. This, in turn, causes the wheel rim 239 to rotate, thereby rotating the traction wheel 238 to rotate and thus imparting forward motion to the device 210.

The driving force from the propulsion device 210 is translated to the user by the skater support bar 216 which will push on the user's leg, or in some cases, the user's legs. The geometry of the skater support bar 216 and hand grips 241,242 is preferably selected to position the support bar 216 at the back or side of the user's lower thigh or behind the user's knee when the user 50 is riding a skateboard 60. In this arrangement, described previously, the user 50 conventionally uses a stance in which one foot is positioned on the forward end of the skateboard 60 and the other foot is positioned near the rearward end of the skateboard 60, thereby defining a forward leg and a rearward leg. In similar manner to that illustrated in FIG. 5A, the support bar 216 is perhaps best placed against the user's rearward leg.

Notably, during more acrobatic and aggressive riding the user 50 can choose to be pushed by holding on to just the lower hand grip 242, just the upper hand grip 241, just some other portion of the upper end of the main support handle 211, or some combination thereof. In fact, any combination of the skater support bar 216, lower hand grip 242, upper hand grip 241, or the upper end of the main support handle 211 may be used to translate motive force from the device 210 to the user.

When a user 50 needs to slow down, he or she may actuate the brake lever 232. Braking force is translated via the brake cable 234 to the brake mechanism 230, thereby slowing or stopping the traction wheel 238 which in turn slows the user 50 to the desired speed or a complete stop.

During use, the user 50 may also choose to lift the traction wheel 238 off the ground, either to quickly disengage the driving force imparted thereby, to provide greater maneuverability, to perform a trick or other acrobatic maneuver, or the like. In such a situation, the upper and lower handle grips 241,242 may be used to lift the entire device 210 off of the ground to the desired position. FIG. 5B is a left side view of the device 210 of FIG. 1, illustrating the use of the device 210 when lifted off the ground for jumps, tricks or the like.

Preferably, when not in use, the propulsion device 210 of the present invention may be collapsed or folded to a compact state, thereby making transport and storage more convenient. As described previously, the upper support handle 211 preferably comprises a separate assembly that may be moved relative to the lower support handle 212 when a suitable securing mechanism is released. More particularly, the upper support handle 211 is preferably connected to the lower support handle 212 by a hinge mechanism 220 and a securing mechanism. The hinge mechanism 220 may be a dedicated hinge disposed on the side or front of the lower support handle 212 and around which the upper support handle 211 may be rotated relative to the lower support handle 212 when the securing mechanism is released. In this regard, the securing mechanism may be as simple as a single conventional bolt, preferably having a finger wheel that may be tightened sufficiently by hand (i.e., without the use of tools) to maintain the relative rigidity of the upper support handle 211 relative to the lower support handle 212 but which may be loosened by hand and removed easily when the user desires to collapse or fold the device 210 into the compact state. The hinge mechanism 220 and securing mechanism are preferably disposed in locations suitable for making the propulsion device as compact as is reasonably possible.

In each of the illustrated embodiments, the upper hand grip 41,141,241 is spaced apart from the respective lower hand grip 42,142,242, thereby providing stability to skateboarders as well as inline or roller skaters that choose to twist their upper bodies somewhat sideways while skating in order to gain such stability. Furthermore, the engine 14,114,214 in each device 10,110,210 is moved upward and away from the wheel 38,138,238 in order to provide better balance to the device and to permit the device 10,110,210 to be lifted more easily by the user 50 for greater maneuverability, to perform tricks and stunts, or the like.

It will be apparent to those skilled in the art that changes and modifications may be made in the embodiments illustrated, without departing from the scope and spirit of the present invention. Therefore the present invention is not limited to the to the particular forms described herein. Possible alternative embodiments include but are not limited to the items described below.

Different combinations of and types of motors or engines could be used. For example, any of the combustion engines 14,114,214 could be replaced with an electric motor.

With specific regard to the second preferred embodiment, shown in FIGS. 7-11, the method of translating rotational torque 90 degrees through the drive gear 128 to the wheel rim via the driven gear 126 could be alternatively achieved by replacing the drive gear with a knurled, roughened or toothed spindle which would drive the side of traction wheel 138 or wheel rim via friction. Alternately this desired result could be achieved by mounting a gear box on the end of drive shaft housing, attached to the drive shaft 115. In such an arrangement, a wheel rim equipped to receive the output shaft on the gearbox would be utilized, with a traction wheel mounted thereon. Further, the assembly of wheel rim with driven gear 126 and friction wheel 138 could be replaced with many different assemblies including but not limited to, multiple wheels, an endless track, or different shapes of traction wheels, or a propeller or impellor to create thrust in a fluid. Of course, these approaches could be applied to the first and third preferred embodiments as well.

The combustion engines 14,114,214 or electric motors mentioned above could be mounted at different locations along the overall length of the respective devices 10,110,210 to achieve different kinds of weight balance. For example, if the motor was mounted closer to the wheel, this would provide more traction and less weight in the user's hands. Further, the combustion engines 14,114,214 or electric motors mentioned above could be mounted in different orientations.

In other alternative features and variations, an outrigger with an idling wheel or skid could be mounded to any of the devices 10,110,210 to supply even more balance. Any of the wheel assemblies could be mounted to the respective devices 10,110,210 in such a way to allow flexing which would cushion impacts and road imperfections felt by the user while skateboarding, skating or the like. The respective upper support handles 11,111,211 could each be made to fold in other ways to allow an even more compact size.

Based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to its preferred embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

What is claimed is:

1. A propulsion device for use with skate equipment, comprising:
(a) a frame having an upper end and a lower end;
(b) an engine mounted substantially above the lower end of the frame;
(c) a single wheel mounted at the lower end of the frame and operatively connected with the engine to be driven thereby; and
(d) a hand grip mounted on the frame above the engine and angled upward away from the frame when the propulsion device is placed in its normal angle of use.

2. The propulsion device of claim 1, wherein the hand grip is spaced substantially apart from the upper end of the frame.

3. The propulsion device of claim 2, further comprising a skater support bar mounted on the frame above the engine and below the hand grip and adapted to provide motive force from the frame to a skater's leg.

4. The propulsion device of claim 3, wherein the hand grip is a first hand grip, the propulsion device further comprising a second hand grip adjacent the upper end of the frame.

5. The propulsion device of claim 3, wherein the engine is arranged to be closer to the hand grip than to the lower end of the frame.

6. The propulsion device of claim 3, wherein the frame includes an upper support handle and a lower support handle.

7. The propulsion device of claim 6, further comprising a hinge mechanism and a securing mechanism, and wherein the upper support handle may be rotated relative to the lower support handle via the hinge mechanism.

8. The propulsion device of claim 6, wherein the engine is mounted at an upper end of the lower support handle, wherein the lower support handle includes a drive shaft housing, and wherein the propulsion device further comprises a drive shaft, extending through the drive shaft housing, that operatively couples rotational motion generated by the engine to the wheel.

9. The propulsion device of claim 3, further including a centrifugal clutch coupled to the engine.

10. The propulsion device of claim 9, further comprising a drive assembly including a drive gear operatively coupled to the centrifugal clutch, a drive shaft operatively coupled to the drive gear, and a driven gear operatively coupled to the drive shaft, wherein the driven gear is mounted on the wheel and imparts motion thereto.

11. The propulsion device of claim 9, further comprising a drive assembly including a drive sprocket operatively coupled to the centrifugal clutch, a chain operatively coupled to the drive sprocket, and a driven sprocket operatively coupled to the chain, wherein the driven sprocket is mounted on the wheel and imparts motion thereto.

12. The propulsion device of claim 3, further comprising a brake lever that is equipped to be adjusted from a position adapted for use by a right-handed user to a positioned adapted for use by a left-handed user.

13. The propulsion device of claim 3, wherein the hand grip is angled to one side of the frame.

14. The propulsion device of claim 13, wherein the hand grip is equipped to be selectively angled to one side of the frame or the other.

15. The propulsion device of claim 3, wherein the hand grip is angled upward away from the frame in an orientation slightly above horizontal when the propulsion device is placed in its normal angle of use.

16. The propulsion device of claim 3, wherein the upward angle of the hand grip is adjustable.

17. A method of propelling a skate equipment user, comprising:
(a) providing propulsion device, including:
(i) a frame having an upper end and a lower end;
(ii) an engine mounted substantially above the lower end of the frame;
(iii) a single wheel mounted at the lower end of the frame and operatively connected with the engine to be driven thereby; and
(iv) a hand grip mounted on the frame above the engine and angled upward away from the frame when the propulsion device is placed in its normal angle of use; and
(b) holding, by the user, the propulsion device at the user's side, the step of holding including gripping the first hand grip with one hand and the gripping the upper end of the frame with the other hand.

18. The method of claim 17, further comprising the steps of imparting rotational force via the engine to the wheel and placing the wheel on the ground to provide forward motion to the device.

19. The method of claim 18, further comprising the step of lifting the device, thereby lifting the wheel off of the ground, in order to maneuver the skate equipment.
